(19) United States
(12) Patent Application Publication
(10) Pub. No.: US 2009/0136723 A1
(43) Pub. Date: May 28, 2009

(54) COATED PLASTIC SHEET, A METHOD FOR PREPARING SAME, AND A HOUSING USING SAME

(76) Inventors: Lihong Zhao, Shenzhen (CN); Wenhai Luo, Shenzhen (CN); Xijing Liu, Shenzhen (CN)

Correspondence Address: BRINKS HOFER GILSON & LIONE, P.O. BOX 10395, CHICAGO, IL, 60610, US

(21) Appl. No.: 12/258,065

(22) Filed: Oct. 24, 2008

(30) Foreign Application Priority Data
Nov. 28, 2007 (CN) 200710196526.1

(51) Int. Cl. B32B 5/00; B05D 1/00; B44C 1/22; C25D 5/02

(52) U.S. Cl. 428/195.1; 427/210; 216/37; 205/118; 205/80

(57) ABSTRACT

A coated plastic sheet comprises a transparent plastic sheet having a top and bottom surface, and a first film on the top surface and covering less than all of the top surface, thereby creating at least one uncovered area. At least a portion of the first film has a first metallic luster on its exposed surface. The coated plastic sheet also comprises a second film on the bottom surface. At least a portion of the second film is visible through the uncovered area of the sheet, wherein the second film presents a second metallic luster through the uncovered area.

The present application claims priority to Chinese Patent Application No. CN200710196526.1, filed Nov. 28, 2007, the entirety of which is hereby incorporated by reference.

### FIELD OF THE DISCLOSURE

The present disclosure relates to a coated plastic sheet, a method for preparing same, and a housing using same.

### BACKGROUND OF THE DISCLOSURE

Plastic housing is widely used in the electronic products since it has a light weight, a low price and other advantages. With the development of the portable electronic industry, the requirement of metallic housing is increasing. Conventional methods for forming a metallic texture on a plastic product are electroplating and physical vapor deposition (PVD). However, the resulting color of the metallic texture in these methods is relatively simplistic, and the patterns usually lack diversity. CN 1470677A discloses a method of laser carving and plating. The method comprises: selecting a transparent plastic material; retreating the front surface of the plastic material with a metallic paint; laser-carving the pretreated plastic material to form a required pattern; coating the whole back surface of the plastic material with a transparent anti-plating agent; and plating the plastic material. The process disclosed in CN 1470677A however is rather complex and can provide only simplistic color on the plated surface. The patterns also lack three-dimensional effect.

### SUMMARY OF THE DISCLOSURE

In one aspect, a coated plastic sheet comprises a transparent plastic sheet having a top and bottom surface, and a first film on the top surface and covering less than all of the top surface, thereby creating at least one uncovered area. At least a portion of the first film has a first metallic luster on its exposed surface. The coated plastic sheet also comprises a second film on the bottom surface. At least a portion of the second film is visible through the uncovered area of the sheet, wherein the second film presents a second metallic luster through the uncovered area.

In another aspect, a method for preparing a coated plastic sheet comprises forming a first film on a top surface of a transparent plastic sheet. The first film covers less than all of the top surface, thereby creating at least one uncovered area. At least a portion of the first film has a first metallic luster on its exposed surface. The method further comprises forming a second film on a bottom surface of the transparent plastic sheet. At least a portion of the second film is visible through the uncovered area of the sheet. The second film presents a second metallic luster through the uncovered area.

In yet another aspect, a housing comprising a coated plastic sheet. The coated plastic sheet comprises a transparent plastic sheet having a top and bottom surface, and a first film on the top surface and covering less than all of the top surface, thereby creating at least one uncovered area. At least a portion of the first film has a first metallic luster on its exposed surface. The coated plastic sheet also comprises a second film on the bottom surface. At least a portion of the second film is visible through the uncovered area of the sheet, wherein the second film presents a second metallic luster through the uncovered area.

### DESCRIPTION OF THE DRAWINGS

FIG. 1 is the cross-sectional view of the coated plastic sheet prepared in Example 1.

FIG. 2 is the front view of the coated plastic sheet according to one embodiment of the present invention.

### DETAILED DESCRIPTION OF THE PREFERRED EMBODIMENTS

According to one embodiment, a coated plastic sheet is provided. The coated plastic sheet comprises a transparent plastic sheet having a top and bottom surface. The coated plastic sheet further comprises a first film on the top surface and covering less than all of the top surface, thereby created at least one uncovered area. At least a portion of the first film has a first metallic luster on its exposed surface. The coated plastic sheet also comprises a second film on the bottom surface, at least a portion of which is visible through the uncovered area of the sheet. The second film presents a second metallic luster through the uncovered area. Preferably, the second film covers at least the part of the bottom surface corresponding to the uncovered area. More preferably, the second film covers substantially the whole bottom surface. The transparent plastic sheet may be translucent or color-tinted. Preferably, both the first film and the second film present a metallic luster when viewed from the top surface side. Preferably, the first film and the second film present different colors.

The coating material of the first film and the second film can be any suitable material that has a metallic luster. Preferably, it is selected from the group consisting of Cut Cr, Ti, Ag, Ni, Ag, Al, Zn, Sn, TiN, TiAlN, TiAlC, TiC, diamond-like carbon and combinations thereof.

The first film and the second film can be independently metallic paints. The metallic paints can be either front-view metallic paints or back-view metallic paints. When a front-view metallic paint is coated on a transparent material, it presents a metallic luster only when viewed from the coated surface side. It does not present any metallic luster when viewed from the uncoated surface side through the transparent material. Thus front-view metallic paints can only be used as the first film. Examples of front-view metallic paints include series DSMT200, series DSMT100, and series DSMT100P metallic paints from Guangzhou Color Paints Company. When a back-view metallic paint is coated on a transparent material, it presents a metallic luster only when viewed from the uncoated surface side through the transparent material. It does not present any metallic luster when viewed from the coated surface side. Thus the back-view metallic paint can only be used as the second film. Examples of back-view metallic paints include series MIT1000, series MI400-01, and series MI1000 metallic paints from Guangzhou Color Paints Company.

The thickness of the first film and the second film can be either identical or different, provided that it is larger than about 0.03 um. Preferably, it is in a range of about 0.05 to 3 um.

In order to achieve a high adhesive property of the surfaces, and to obtain a good coating on the top surface, the plastic sheet may further comprise a base layer disposed between the top surface and the first film. The base layer can be any suitable base coatings. For example, it can be selected from the group consisting of polyester acrylate, epoxy acrylate, polyurethane acrylate and combinations thereof.

In order to achieve a good wearing-resistance property of the plastic sheet, the plastic sheet may further comprise a finishing layer. The finishing layer is disposed on the exposed surface of the first film and/or the second film. The finishing layer can be any suitable finishing coatings. For example, it can be selected from the group consisting of polyester acrylate, epoxy acrylate, polyurethane acrylate and combinations thereof.

The transparent plastic material can be any suitable transparent plastic materials. For example, it can be selected from the group consisting of transparent polycarbonate (PC), acrylate-butadiene-styrene (ABS) and polymethylmethacrylate (PMMA) and combinations thereof.

In another embodiment, a method for preparing the coated plastic sheet is provided. The method comprises forming a first film on a top surface of a transparent plastic sheet. The first film covers less than all of the top surface, thereby created at least one uncovered area. At least a portion of the first film has a first metallic luster on its exposed surface. The method further comprises forming a second film on a bottom surface of the transparent plastic sheet. At least a portion of the second film is visible through the uncovered area of the sheet. The second film presents a second metallic luster through the uncovered area.

The first film may be formed by applying a coating material onto the top surface of the transparent plastic sheet, and then partially removing the first coating material according to a pre-determined pattern. The second film may be formed by applying a coating material onto the bottom surface of the transparent plastic sheet. The second film preferably covers at least the part of the bottom surface corresponding to the uncovered area. For convenience of operation, preferably, the second coating layer covers substantially the entire bottom surface.

The method for applying a coating onto the surface of the transparent plastic sheet can be any suitable method. For example, it can be electroplating, physical vapor deposition (PVD) (including vacuum evaporation, magnetron sputtering and ion plating), metal spraying, ink printing, or the like.

The method for partially removing the first coating material can be any suitable manual or mechanical method, provided it can remove the coating without substantially damaging the substrate. For example, it can be selected from the group consisting of hand-carving, laser carving, chemical etching and combinations thereof.

The first film and the second film can use any suitable substance that presents a metallic luster. Preferably, it is selected from the group consisting of Cu, Cr, Ti, Ag, Ni, Ag, Al, Zn, Sn, TiN, TiAlN, TiAlC, TiC, diamond-like carbon and combinations thereof.

The first film and the second film also can be independently metal paints. The metallic paints comprise front-view metallic paints and back-view metallic paints. When a front-view metallic paint is coated on a transparent material, it presents a metallic luster only when viewed from the coated surface side. It does not present any metallic luster when viewed from the uncoated surface side through the transparent material. Thus, front-view metallic paints can only be used as the first film. Examples of front-view metallic paints include series DSMT200, series DSMT100, and series DSMT100P metallic paints from Guangzhou Color Paints Company. When a back-view metallic paint is coated on a transparent material, it presents a metallic luster only when viewed from the uncoated surface side through the transparent material. It does not present any metallic luster when viewed from the coated surface side. Thus, back-view metallic paints can only be used as the second film. Examples of back-view metallic paints include series MIT1000, series MI400-01, and series MI1000 metallic paints from Guangzhou Color Paints Company.

In order to achieve a high adhesive property of the surfaces, and to obtain a good coating on the top surface, the plastic sheet further comprises a base layer disposed between the top surface and the first film. The base layer can be any suitable base coatings. For example, it can be selected from the group consisting of polyester acrylate, epoxy acrylate, polyurethane acrylate and combinations thereof.

In order to achieve a good wearing-resistance property of the plastic sheet, the plastic sheet further comprises a finishing layer. The finishing layer is disposed on the exposed surface of the first film and/or the second film. The finishing layer can be any suitable finishing coatings. For example, it can be selected from the group consisting of polyester acrylate, epoxy acrylate, polyurethane acrylate and combinations thereof.

The transparent plastic material can be any suitable transparent plastic materials. For example, it can be selected from the group consisting of transparent polycarbonate (PC), acrylate-butadiene-styrene (ABS) and polymethylmethacrylate (PMMA) and combinations thereof.

Preferably, the method for preparing the coated plastic sheet is as follows:

(1) select a transparent plastic sheet with smooth surfaces, such as transparent PC, ABS or PMMA;

(2) use alcohol or acetone to remove any impurity from both surfaces;

(3) spray a base coating material onto the top surface of the transparent plastic sheet to form a base layer with a thickness of about 8 to12 um;

(4) dry the base layer;

(5) apply a coating material onto the coated surface by physical vapor deposition (PVD) to form a first film;

(6) dry the first film;

(7) engrave a pre-determined pattern on the first film using laser carving, and control the carving depth by regulating the electric current of the laser source; preferably, the carving is deep enough to expose the plastic sheet;

(8) spray a back-view metallic paint onto the bottom surface of the transparent plastic sheet to form a second film;

(9) dry the second film; and

(10) spray a finishing coating material on the first film to form a finishing layer.

In yet another embodiment, a housing using the coated plastic sheet is provided. The housing is made of a plastic sheet with two coatings with a three-dimensional effect. The first surface of the plastic sheet is used as an exterior surface. The second surface is used as an inner surface. The housing can be used for any suitable products. For example, it can be used for cell phones, PDAs, MP3s, MP4s, computers, notebooks, pencil-boxes, artworks and other products.

The present invention is illustrated in detail by the below Examples and drawings.

### EXAMPLE 1

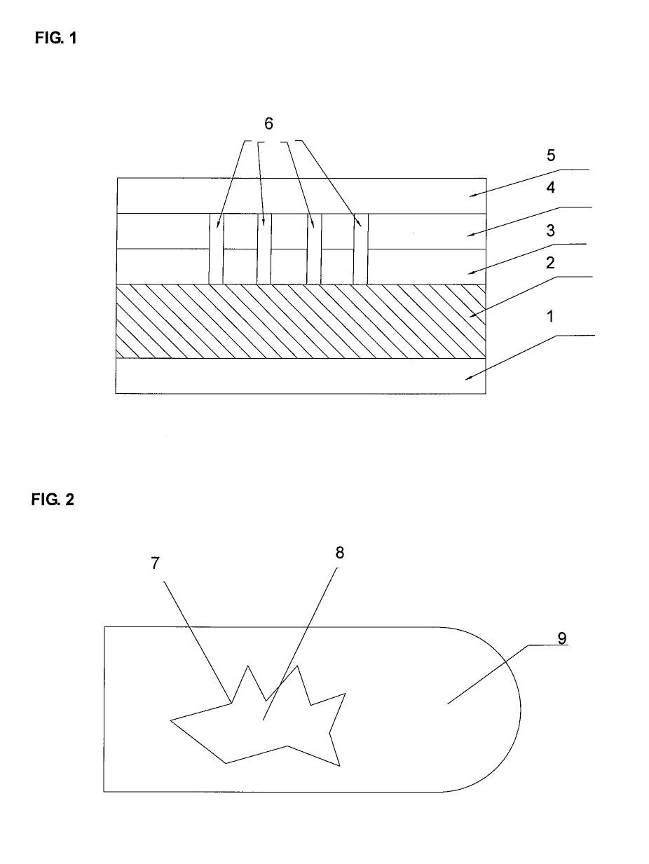

This example illustrates a method for preparing the plastic sheet as shown in FIG. 1. The method comprises the following steps.

(i) Alcohol was used to clean both surfaces of a 0.9 mm thick transparent PC sheet (2).

(ii) Polyester acrylate was sprayed onto the top surface of the transparent plastic sheet to form a base layer (3); and the base layer has a thickness of about 10 um.

(iii) The base layer was dried.

(iv) Chromium was applied onto the coated surface by physical vapor deposition (PVD) to form the first film (4).

The detailed operation of step (iv) is as follows.

Plating type: sputter coating.

Plating material: chromium.

Pretreatment: O₂ was flushed at a speed of about 270 sccm (standard condition, cubic centimeter per minute) for about 5 seconds and ionized with about 600 W of RF (radio frequency power) for about 10 seconds. The PC sheet was cleaned in the oxygen ion atmosphere.

Plating: argon gas was flushed at a speed of about 90 sccm.

Total plating time is about 36 seconds. The change of the plating power with the time is shown in table 1.

TABLE 1

| | Serial Number | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Power (W) | 2500 | 3000 | 3500 | 4000 | 2500 | 3000 | 3500 | 4000 | 2500 | 3000 | 3500 | 4000 |
| Time (s) | 2 | 2 | 2 | 2 | 3 | 3 | 3 | 3 | 4 | 4 | 4 | 4 |

(v) The chromium plated plastic sheet was dried.

(vi) The first film was laser-engraved to form the required pattern (6), using an EPYAG25 laser equipment at an electric current of about 12 A.

(vii) A DSMT100P series metallic paint was prepared and sprayed on the bottom surface of the transparent plastic sheet to form the second film (1).

(viii) The second film was dried at about 70 degree for about 2 hours.

(ix) Polyester acrylic acid oligomer was sprayed on the first film and dried to form a finishing layer (5).

The plastic material with dual metallic tones was obtained. The external appearance of the obtained plastic sheet is showed in FIG. 2. Line (7) is the edge of the required pattern (8). The area of the pattern (8) is not covered with the first film. Part (9) is the portion of the first film. The second film can be seen through the transparent plastic sheet in the area of the pattern (8). As a result, the plastic sheet product has a diversified dual metallic tone with three dimensional effects.

Many modifications and other embodiments of the present disclosure will come to mind to one skilled in the art to which the present disclosure pertains having the benefit of the teachings presented in the foregoing description; and it will be apparent to those skilled in the art that variations and modifications of the present disclosure can be made without departing from the scope or spirit of the present disclosure. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A coated plastic sheet, comprising:
a transparent plastic sheet having a top and bottom surface;
a first film on the top surface and covering less than all of the top surface, thereby creating at least one uncovered area, at least a portion of the first film has a first metallic luster on its exposed surface; and
a second film on the bottom surface, at least a portion of which is visible through the uncovered area of the sheet, wherein the second film presents a second metallic luster through the uncovered area.

2. The coated plastic sheet of claim 1, wherein the second film covers substantially the entire bottom surface.

3. The coated plastic sheet of claim 1, wherein the second film presents the second metallic luster on substantially the entire uncovered area.

4. The coated plastic sheet of claim 2, wherein the second film presents the second metallic luster on substantially the entire bottom surface.

5. The coated plastic sheet of claim 1, wherein the first metallic luster and the second metallic luster are different in color.

6. The coated plastic sheet of claim 1, wherein the first film and the second film independently comprise a metallic paint.

7. The coated plastic sheet of claim 1, wherein the first film and the second film independently comprises a coating material selected from the group consisting of Cu, Cr, Ti, Ni, Ag, Al, Zn, Sn, TiN, TiAlN, TiAlC, TiC, diamond-like carbon, and combinations thereof.

8. The coated plastic sheet of claim 1, wherein the thickness of the first film and the second film is independently in the range of about 0.05 to 3 μm.

9. The coated plastic sheet of claim 1, further comprising a primer layer disposed between the top surface and the first film.

10. The coated plastic sheet of claim 1, further comprising a finishing layer disposed on the first film.

11. The coated plastic sheet of claim 1, further comprising a finishing layer disposed on the second film.

12. The coated plastic sheet of claim 1, wherein the transparent plastic sheet comprises a material selected from the group consisting of polycarbonate, acrylonitrile-butadiene-styrene, polymethylmethacrylate, and combinations thereof.

13. A method for preparing a coated plastic sheet, comprising
forming a first film on a top surface of a transparent plastic sheet, the first film covering less than all of the top surface, thereby creating at least one uncovered area, at least a portion of the first film has a first metallic luster on its exposed surface; and
forming a second film on a bottom surface of the transparent plastic sheet, wherein at least a portion of the second film is visible through the uncovered area of the sheet, wherein the second film presents a second metallic luster through the uncovered area.

14. The method of claim 13, wherein the second film covers substantially the entire bottom surface.

15. The method of claim 13, wherein the first metallic luster and the second metallic luster are different in color.

16. The method of claim 13, wherein forming the first film comprises:
applying a coating material onto the top surface of the transparent plastic sheet; and
partially removing the coating material from the top surface to form the first film and the uncoated area.

17. The method of claim 16, wherein the partially removing step comprises hand-carving, laser carving, chemical etching, or combinations thereof.

18. The method of claim 16, wherein the coating material is partially removed based on a pre-determined pattern.

19. The method of claim 16, wherein the coating material is applied onto the top surface by electroplating, physical vapor deposition, metal spraying, or ink printing.

20. The method of claim 13, wherein forming the second film comprises:
applying a coating material onto the bottom surface of the transparent plastic sheet.

21. The method of claim 20, wherein the coating material is applied onto the bottom surface by electroplating, physical vapor deposition, metal spraying, or ink printing.

22. The method of claim 13, wherein the first film and the second film independently comprise a metallic paint.

23. The method of claim 13, wherein the first film and the second film independently comprise a coating material selected from the group consisting of Cu, Cr, Ti, Ni, Ag, Al, Zn, Sn, TiN, TiAlN, TiAlC, TiC, diamond-like carbon, and combinations thereof.

24. The method of claim 13, further comprising:
forming a primer layer on the top surface of the transparent plastic sheet.

25. The method of claim 13, further comprising:
forming a finishing layer on the first film.

26. The method of claim 13, further comprising:
forming a finishing layer on the second film.

27. The method of claim 13, wherein the transparent plastic sheet comprises a material selected from the group consisting of polycarbonate, acrylonitrile-butadiene-styrene, polymethylmethacrylate, and combinations thereof.

28. A housing comprising:
a coated plastic sheet, the coated plastic sheet comprising:
a transparent plastic sheet having a top and bottom surface;
a first film on the top surface and covering less than all of the top surface, thereby creating at least one uncovered area, at least a portion of the first film has a first metallic luster on its exposed surface; and
a second film on the bottom surface, at least a portion of which is visible through the uncovered area of the sheet, wherein the second film presents a second metallic luster through the uncovered area.
